(19) United States
(12) Patent Application Publication
(10) Pub. No.: US 2003/0114189 A1
(43) Pub. Date: Jun. 19, 2003

(54) Voice alarm apparatus and method for mobile communication terminal

(75) Inventor: Byoung-Seoup Moon, Suwon-shi (KR)

Correspondence Address: PAUL J. FARRELL, ESQ., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/205,885

(22) Filed: Jul. 26, 2002

(30) Foreign Application Priority Data
Dec. 15, 2001 (KR) P2001-79755

(51) Int. Cl. H04M 1/00

(52) U.S. Cl. 455/556; 455/564; 455/550

(57) ABSTRACT

An apparatus for outputting a voice alarm in a mobile communication terminal is provided. The apparatus includes a voice synthesizer (or Text-To-Speech (TTS) converter) for converting text data into voice data, a memory for storing alarm contents and an alarm time input by a user, a controller for converting the alarm contents stored in the memory into voice data by the voice synthesizer at the alarm time and transmitting the voice data to a coder-decoder (CODEC). The CODEC converts the voice data from the controller into an analog voice signal and outputs the analog voice signal through a speaker.

### PRIORITY

This application claims priority to an application entitled “Voice Alarm Apparatus and Method for a Mobile Communication Terminal” filed in the Korean Industrial Property Office on Dec. 15, 2001 and assigned Serial No. 2001-79755, the contents of which are hereby incorporated by reference.

### BACKGROUND OF THE INVENTION

1. Field of the Invention

The present invention relates generally to a mobile communication terminal, and in particular, to an apparatus and method for alarming a user by voice in a mobile communication terminal.

2. Description of the Related Art

In general, a mobile communication terminal includes a cellular phone, a PCS (Personal Communication System) phone, a personal data assistant (PDA), and an IMT-2000 (International Mobile Telecommunication-2000) terminal.

The popularity of mobile communication terminals is rapidly increasing because of its ready portability, among other features, and service providers (terminal manufacturers) are competitively developing terminals having special functions in order to secure more users. For example, the mobile communication terminal provides various functions such as phone book, game, scheduler, short message service, Internet, e-mail, and morning call functions. The scheduler function registers contents that are easily forgotten by a user, such as holidays, birthdays, appointments, and meetings, and alarms the user on the days entered by the user, to thus remind the user of the days.

In a conventional technology, a designated melody is reproduced in order to alarm a user in almost all cases. After the user listens to the melody, the user checks an alarm contents by manipulating the terminal. According to this method, it is difficult for the user to check the alarm contents when the user cannot manipulate the terminal. For example, the user cannot check the alarm contents when the user is driving a car.

### SUMMARY OF THE INVENTION

It is, therefore, an object of the present invention to provide an apparatus for generating a voice alarm in a mobile communication terminal, and a method therefor.

It is another object of the present invention to provide an apparatus for generating a voice alarm using a voice synthesizing (or text-to-speech (TTS) conversion) technique, and a method therefor.

To achieve the above and other objects, the present invention provides an apparatus for outputting a voice alarm in a mobile communication terminal. The apparatus includes a voice synthesizer for converting text data into voice data; a memory for storing alarm contents and an alarm time input by a user; a controller for converting the alarm contents stored in the memory into voice data by the voice synthesizer at the alarm time and transmitting the voice data to a coder-decoder (CODEC), and the CODEC for converting the voice data from the controller into an analog voice signal and outputting the analog voice signal through a speaker.

Further, the present invention provides a method for outputting a voice alarm in a mobile communication terminal with a voice synthesizing function. The method comprises storing alarm contents and an alarm time input by a user in a memory: converting the alarm contents stored in the memory into voice data using the voice synthesizing function at the alarm time; and converting the voice data into a voice signal and outputting the voice signal through a speaker.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication terminal according to an embodiment of the present invention;

FIG. 2 illustrates a control process of setting an alarm in a mobile communication terminal according to an embodiment of the present invention;

FIG. 3 illustrates a control process of generating a scheduled voice alarm in a mobile communication terminal according to an embodiment of the present invention; and

FIG. 4 illustrates an example of a window for setting the alarm.

### DETAILED DESCRIPTION OF THE PREFERRED EMBODIMENT

A preferred embodiment of the present invention is described herein with reference to the accompanying drawings. In the following description, well-known functions or constructions are not described in detail since they would obscure the invention in unnecessary detail.

A technology of generating a voice alarm in order to inform a user of a scheduled event that was previously input in a mobile communication terminal will now be described.

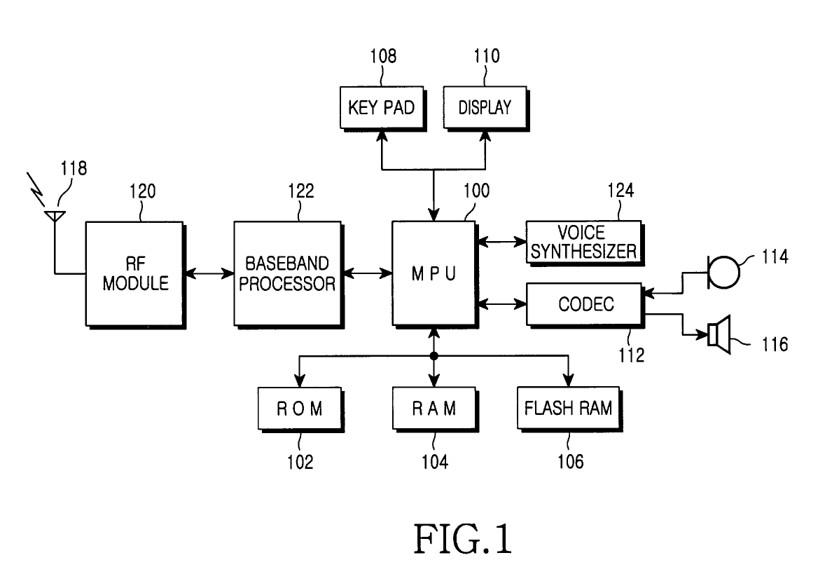

FIG. 1 shows a block diagram of a mobile communication terminal according to an embodiment of the present invention. The mobile communication terminal includes a cellular phone, a PCS (Personal Communication System) phone, a personal data assistant (PDA), and an IMT-2000 (International Mobile Telecommunication-2000) terminal. A general structure of such terminals will now be described.

Referring to FIG. 1, a controller 100, i.e. microprocessor unit (MPU), typically controls the operation of the mobile communication terminal. For example, the controller 100 processes and controls a voice call and data communication, and performs an operation of generating an alarm by voice according to the present invention in addition to its common functions.

A read only memory (ROM) 102 stores microcodes of a program for processing and controlling the controller 100, and stores various reference data. In particular, the ROM 102 stores a program for generating an alarm used by a scheduler by voice according to the present invention. A random access memory (RAM) 104, typically a working memory of the controller 100, stores temporary data generated during execution of various programs. A flash RAM 106 stores various updateable data such as the data used for a scheduler and a phone book.

A key pad 108 includes number keys of 0 through 9, a MENU key, a CONFIRM key, a SEND key, a TALK key, a CLR (Clear) key, an END key, a * - key, a #-key, and a navigation key (up, down, left, and right), and provides key input data corresponding to the key(s) pressed by a user. A display 110 displays state information generated during the operation of the mobile communication terminal, a number of characters, and/or moving images and still images. A color liquid crystal display (LCD) can be used as the display 110.

A coder-decoder (CODEC) 112 is depicted as connecting the controller 100 to an earpiece (or speaker) 116 and a mouthpiece (or microphone) 114, which constitute a voice input/output block used for a telephone call and voice recording. The CODEC 112 converts PCM (Pulse Code Modulation) data provided from the controller 100 into an analog voice signal, and outputs the analog voice signal through the earpiece 116. Further, the CODEC 112 converts a voice signal received through the mouthpiece 114 into PCM data, and provides the PCM data into the controller 100.

A radio frequency (RF) module 120 down-converts a radio frequency signal received through an antenna 118, and provides the radio frequency signal to a baseband processor 122 in a reception mode. Further, the RF module 120 up-converts a baseband signal from the baseband processor 122, and transmits the baseband signal through the antenna 118 in a transmission mode. The baseband processor 122 processes the baseband signals exchanged between the RF unit 120 and the controller 100. For example, the baseband processor 122 channel-codes and spreads transmission data in the transmission mode, and despreads and channel-decodes a receiving signal in the reception mode.

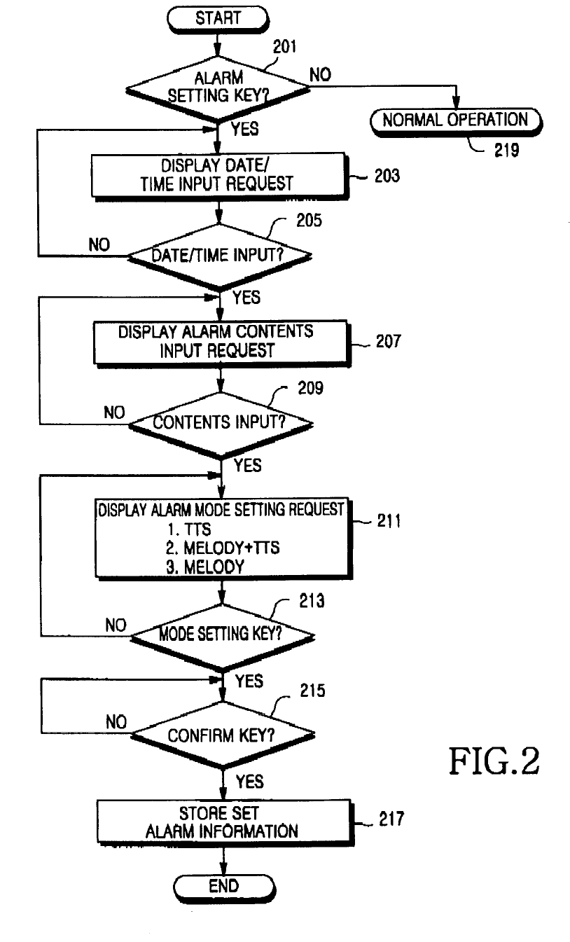

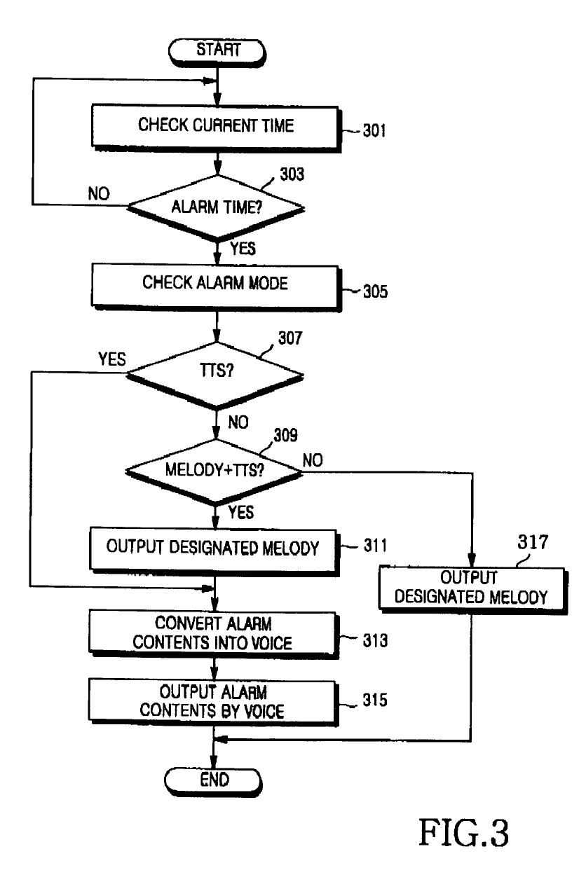

A voice synthesizer 124, a functional block according to the present invention, includes a conversion table for converting the text data at issue into voice data. It is assumed that a TTS (Text-to-Speech) converter is used for the voice synthesizer 124. Therefore, a detailed description of voice synthesizing will be omitted. That is, the voice synthesizer 124 converts the text data at issue, which is provided by the controller 100, into voice data and outputs the voice data to the controller 100. The controller 100 provides the voice data to the CODEC 112. The CODEC 112 converts the voice data from the controller 100 into an analog voice signal, and outputs the analog voice signal through the speaker 116. The controller 100 provides alarm contents stored in the flash RAM 106 to the voice synthesizer 124 at an alarm time according to the present invention. The voice synthesizer 124 converts the alarm contents into voice data with reference to the conversion table, and provides the voice data to the controller 100. Operations will be described in detail with reference to FIGS. 2 and 3.

The operation based on the structure of FIG. 1 will now be described with reference to FIG. 2.

FIG. 2 illustrates a control process for setting a alarm in the mobile communication terminal according to the embodiment of the present invention. The scheduler will now be described among various functions provided by the mobile communication terminal. However, one of skill in the art will recognize that the mobile communication terminal of the present invention can be applied to any alarm or related function. For example, the mobile communication terminal can be applied to a common alarming function, a morning call function, and functions informing the user of holidays, birthdays or other events.

Referring to FIG. 2, the controller 100 determines in step 201 whether a alarm-setting key for entering a scheduled event is input (or selected). When the alarm-setting key is input by the user, the controller 100 enters an alarm-setting mode, and advances to step 203. When the alarm-setting key is not input, the controller 100 performs another function according to its normal operation as in step 219.

After entering the alarm-setting mode, the controller 100 displays a date/time input request message on the display 110 (step 203). At the sight of the message, the user will input the date and time of an alarm to be registered. That is, the controller 100 determines in step 205 whether the date and time are input by the user. When the date and time for the alarm are input, the controller 100 displays a alarm contents input request message in step 207. When the date and time are not input, the controller 100 returns to the step 203, displaying the date/time input request message, or otherwise allowing the user to terminate and depart from the scheduling-setting mode.

After displaying the alarm contents input request message, the controller 100 determines in step 209 whether the alarm contents are input by the user. When the alarm contents are input, the controller 100 proceeds to step 211. Otherwise, the controller 100 returns to the step 207, to display the alarm contents input request message.

When the alarm contents are input by the user, the controller 100 displays an alarm mode setting request message in the step 211. For example, the alarm mode may include a “TTS” mode (or “Voice” mode), a “Melody+TTS” mode (or “Melody-Plus-Voice” mode), and a “Melody” mode. The user may select one of the displayed alarm modes. The controller 100 determines in step 213 whether a mode-setting key for selecting one of the displayed alarm modes is input. When the mode-setting key is input, the controller 100 proceeds to step 215. Otherwise, the controller 100 returns to the step 211, to display the alarm mode setting request message.

The controller 100 determines in step 215 whether the CONFIRM key for completing setting of the alarm is input. When the CONFIRM key is input, the controller 100 stores the set alarm information in a corresponding storage region of the flash RAM 106 in step 217, and then terminates the process.

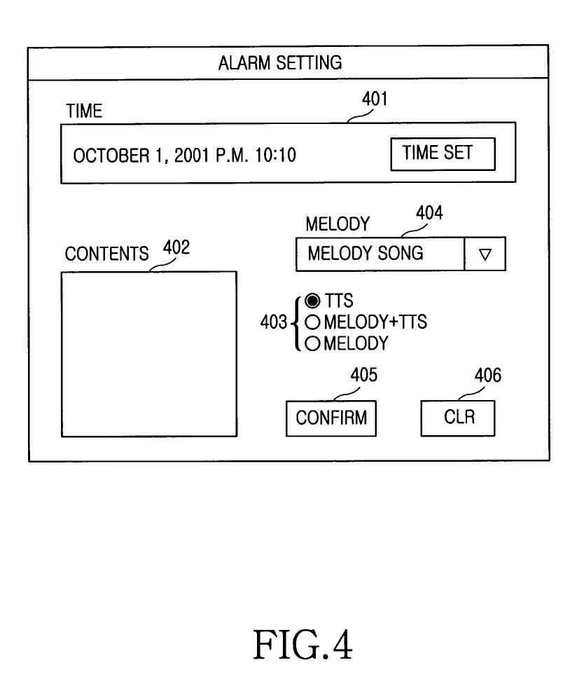

FIG. 4 shows an example of a window for setting an alarm. As shown in FIG. 4, the window includes a first portion 401 for setting an alarm time, a second portion 402 for inputting alarm contents, a third portion 403 for setting an alarm mode, a fourth portion 404 for selecting a melody, a CONFIRM key 405, and a clear (CLR) key 406. A user sets the alarm time in the first portion 401, and inputs the alarm contents to the second portion 402. In the first portion 401, a “Time Set” icon may be provided for ready input of how much earlier in time prior to the alarm time the alarm is to be generated (i.e. the alarm time). When the user selects the “Time Set” icon, options such as “Alarm Time”, “Before 30 Minutes” and “Before 1 Hour” are displayed. The user may select one of the displayed options. The user sets a desired alarm mode through the third portion 403, and, if a either the “Melody+TTS” or “Melody” modes are selected, uses the fourth portion 404 to select a melody to be used for alarming the user.

When the user selects the “TTS” mode or the “Melody+TTS” mode among the alarm modes of the third portion 403, the alarm contents input to the second portion 402 are converted into voice, and the voice is output as an alarm. When the user selects either the “Melody” or “Melody+TTS” mode as the alarm mode, the melody selected through the fourth portion 404 is output as an alarm. After setting the alarm time, the alarm mode, the alarm contents, and the melody, the user completes setting of the alarm by pressing the CONFIRM key 405. The set alarm information is stored in a memory, such as that set forth in Table 1.

TABLE 1

| Date and Time | Alarm Mode | Melody | Alarm Contents |
|---|---|---|---|
| Oct. 1, 2001 | TTS (or Voice) | X | Meeting Day |
| p.m. 01:10 | | | |
| Nov. 1, 2001 | Melody + TTS | Waltz | Tenth Wedding Anniversary |
| p.m. 05:00 | | | |
| . . . | . . . | . . . | . . . |
| . . . | . . . | . . . | . . . |

FIG. 3 shows a control process for generating a scheduled voice alarm in a mobile communication terminal according to an embodiment of the present invention.

Referring to FIG. 3, the controller 100 reads an alarm time (the date and time) from Table 1 stored in the memory and checks a current time in step 301. The controller 100 determines in step 303 whether the current time has reached the alarm time. That is, the controller 100 determines whether the current time has reached the alarm time (the date and time) among the information on the alarm registered in the process of FIG. 2. When the alarm time is set, the process of FIG. 3 examines whether the current time has reached the set alarm time.

When it is determined that the current time has reached the alarm time, the controller 100 analyzes the alarm mode among the alarm information in step 305. As mentioned before, the alarm mode includes the “TTS” mode, the “Melody+TTS” mode, and the “Melody” mode. The controller 100 determines in step 307 whether the analyzed alarm mode is the “TTS” mode. That is, it is determined whether the alarm mode is set to output the contents of the alarm by voice. When the alarm mode is set to the “TTS” mode, the controller 100 proceeds to step 313. Otherwise, when the alarm mode is not set to the “TTS” mode, the controller 100 determines in step 309 whether the alarm mode is set to the “Melody+TTS” mode. That is, it is determined whether the alarm mode is set to first output a melody and then output the alarm contents by voice. When the alarm mode is set to the “Melody+TTS” mode, the controller 100 proceeds to step 311. Otherwise, when the alarm mode is set to the “Melody” mode, the controller 100 outputs the melody designated for the alarm to the outside in step 317. The melody is output at least once, according to a predetermined number of times.

When the alarm mode is set to the “Melody+TTS” mode, the controller 100 outputs the previously designated melody to the outside in step 311. Thereafter, the controller 100 converts the registered alarm contents (i.e. text data) into voice data via the voice synthesizer 124 in the step 313. The controller 100 converts the converted voice data into a voice signal utilizing CODEC 112, and outputs the voice signal to the speaker 116 in step 315. The contents of the alarm can be repeatedly output a predetermined number of times.

As mentioned above, when the alarm mode is set to the “TTS” mode, the registered alarm contents are converted into voice and the voice is output. When the alarm mode is set to the “Melody+TTS” mode, the designated melody is first output, and then the alarm contents are converted into voice and output. When the alarm mode is set to the “Melody” mode, only the designated melody is output.

For example, as to a first alarm item in Table 1, the alarm mode of the first alarm item is set to the “TTS” mode, so “Meeting Day”, i.e. the registered alarm contents that were input with the other alarm information, is converted into voice and the voice is output as an alarm.

As mentioned above, the voice alarm apparatus according to the present invention outputs the alarm contents by voice, so the user need not visually check the alarm contents, which is especially useful in situations such as when the user drives a car. In addition, the user can check the alarm contents without separate manipulation even in a normal situation, offering convenience to the user.

While this invention has been particularly shown and described with reference to preferred embodiments thereof, it will be understood by those skilled in the art that various changes in form and detail may be made without departing from the spirit and scope of the invention, as defined by the appended claims.

What is claimed is:

1. An apparatus for outputting a voice alarm in a mobile communication terminal, comprising:
a voice synthesizer for converting text data into voice data;
a memory for storing alarm contents and an alarm time input by a user; and
a controller for converting the stored alarm contents into voice data by the voice synthesizer and transmitting the voice data to a coder-decoder (CODEC), wherein
the CODEC converts the voice data from the controller into an analog voice signal and outputs the analog voice signal through a speaker at the alarm time.

2. A method for outputting a voice alarm in a mobile communication terminal with a voice synthesizing function, comprising the steps of:
storing alarm contents and an alarm time input by a user in a memory:
converting the stored alarm contents into voice data using the voice synthesizing function; and
converting the voice data into a voice signal and outputting, at the alarm time, the voice signal through a speaker.

3. A method for outputting a voice alarm in a mobile communication terminal with a voice synthesizing function, comprising the steps of:
storing alarm contents and an alarm time input by a user;
setting an alarm mode for the alarm contents to be output at the alarm time;
analyzing the set alarm mode at the alarm time;
converting the stored alarm contents into voice data using the voice synthesizing function when the alarm mode is set to a voice mode; and
converting the voice data into a voice signal and outputting the voice signal through a speaker.

4. The method of claim 3, wherein the alarm contents are output by voice a predetermined number of times.

5. The method of claim 3, further comprising the step of outputting a previously designated melody as an alarm when the alarm mode is set to a melody mode.

6. The method of claim 5, wherein the melody alarm is output a predetermined number of times.

7. The method of claim 3, further comprising the steps of:
outputting a melody alarm prior to outputting the alarm contents when the alarm mode is set to a melody-plus-voice mode.

8. A method for outputting a scheduled voice alarm in a mobile communication terminal with a voice synthesizing function, comprising the steps of:
storing an alarm contents and an alarm time input by a user;
converting the stored alarm contents into voice data using the voice synthesizing function at the alarm time; and
converting the voice data into a voice signal and outputting the voice signal through a speaker.
